(19) United States
(12) Patent Application Publication
(10) Pub. No.: US 2006/0227066 A1
(43) Pub. Date: Oct. 12, 2006

(54) Human machine interface method and device for automotive entertainment systems

(75) Inventors: Hongxing Hu, West Bloomfield, MI (US); Jie Chen, Windsor (CA)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/384,923

(22) Filed: Mar. 17, 2006

Related U.S. Application Data
(63) Continuation-in-part of application No. 11/119,402, filed on Apr. 29, 2005.
(60) Provisional application No. 60/669,951, filed on Apr. 8, 2005.

(51) Int. Cl. G09G 5/00

(52) U.S. Cl. 345/7

(57) ABSTRACT

A human machine interface device for automotive entertainment systems, the device includes user interface input components receiving user drawn characters and selection inputs from a user, and user interface output components communicating prompts to the user. A browsing module is connected to the user interface input components and said user interface output components. The browsing module filters media content based on the user drawn characters, delivers media content to the user based on the selection inputs, and prompts the user to provide user drawn characters and user selections in order to filter the media content and select the media content for delivery.

### CROSS-REFERENCE TO RELATED APPLICATIONS

This application is a continuation-in-part of U.S. patent application Ser. No. 11/119,402 filed on Apr. 29, 2005, which claims the benefit of U.S. Provisional Application No. 60/669,951, filed on Apr. 8, 2005. The disclosures of the above applications are incorporated herein by reference in their entirety for any purpose.

### FIELD

The present invention relates to human machine interfaces and, more particularly, to an improved control interface for a driver of a vehicle.

### BACKGROUND

The statements in this section merely provide background information related to the present disclosure and may not constitute prior art.

Today there are a large number of multimedia programs available from satellite radio, portable media players, hard disc drives, etc. A solution to the problem of searching through a long list of items and finding a particular program quickly and conveniently, without tedium or confusion, has yet to be provided, especially in the context of a driver of a vehicle. Moreover, a solution is needed that avoids tedium and confusion, while still providing a driver of a vehicle full control of a multimedia system. A touchpad with character/stroke recognition capability provides a unique solution to this issue.

### SUMMARY

A human machine interface device for automotive entertainment systems, the device includes user interface input components receiving user drawn characters and selection inputs from a user, and user interface output components communicating prompts to the user. A browsing module is connected to the user interface input components and said user interface output components. The browsing module filters media content based on the user drawn characters, delivers media content to the user based on the selection inputs, and prompts the user to provide user drawn characters and user selections in order to filter the media content and select the media content for delivery.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exemplary perspective view of the instrument panel of a vehicle, showing a typical environment in which the human machine interface for automotive entertainment system may be deployed;

FIG. 2 is a plan view of an exemplary steering wheel, illustrating the multifunction selection switches and multifunction touchpad components;

FIG. 3 is a block diagram illustrating hardware and software components that may be used to define the human machine interface for automotive entertainment systems;

FIG. 4 is a functional block diagram illustrating certain functional aspects of the human machine interface, including the dynamic prompt system and character (stroke) input system;

FIG. 5 illustrates an exemplary tree structure and associated menu structure for the selection of audio-visual entertainment to be performed;

FIG. 6 illustrates how the dynamic prompt system functions.

### DETAILED DESCRIPTION

The following description is merely exemplary in nature and is not intended to limit the present disclosure, application, or uses. It should be understood that throughout the drawings, corresponding reference numerals indicate like or corresponding parts and features.

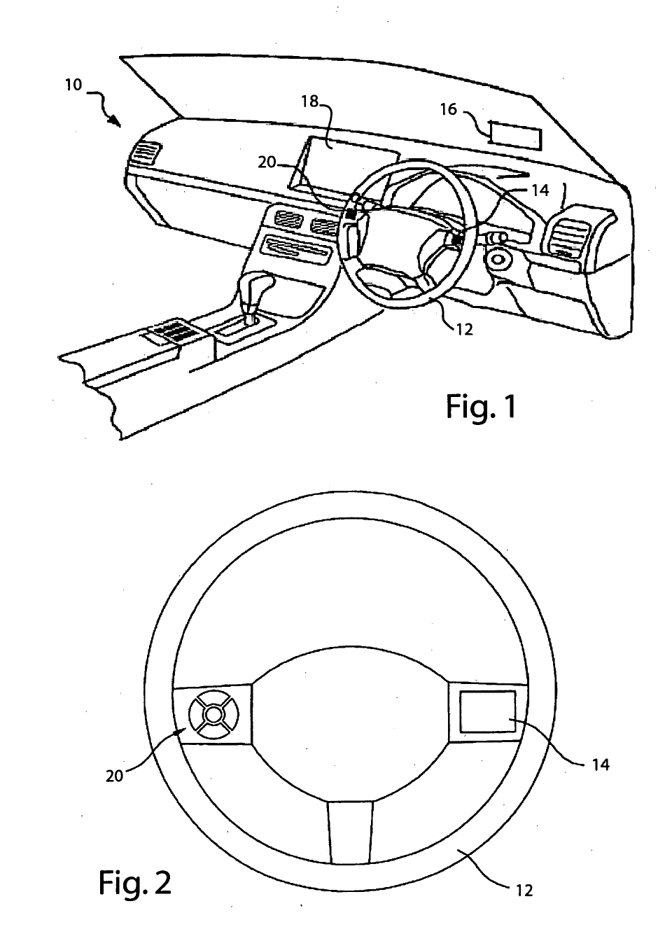

FIG. 1 illustrates an improved human machine interface for automotive entertainment systems in an exemplary vehicle cockpit at 10. The human machine interface allows a vehicle occupant, such as the driver, to control audio-video components mounted or carried within the vehicle, portable digital players, vehicle mounted digital players and other audio-video components.

The human machine interface includes, in a presently preferred embodiment, a collection of multifunction switches 20 and a touchpad input device 14 that are conveniently mounted on the steering wheel 12. As will be more fully explained, the switches and touchpad are used to receive human input commands for controlling the audio-video equipment and selecting particular entertainment content. The human machine interface provides feedback to the user preferably in a multimodal fashion. The system provides visual feedback on a suitable display device. In FIG. 1, two exemplary display devices are illustrated: a heads-up display 16 and a dashboard-mounted display panel 18. The heads-up display 16 projects a visual display onto the vehicle windshield. Display panel 18 may be a dedicated display for use with the automotive entertainment system, or it may be combined with other functions such as a vehicle navigation system function.

It should be readily understood that various kinds of displays can be employed. For example, another kind of display can be one a display in the instrument cluster. Still another kind of display can be a display on the rear view mirror.

It should also be readily understood that operation functionality of the touchpad can be user-configurable. For example, some people like to search by inputting the first character of an item, while others like to use motion to traverse a list of items. Also, people who are generally familiar with an interface of a particular media player can select to cause the touchpad to mimic the interface of that media player. In particular, switches embedded in locations of the touchpad can be assigned functions of similarly arranged buttons of an iPod™ interface, including top for go back, center for select, left and right for seek, and bottom for play&pause. Yet, users familiar with other kinds of interfaces may prefer another kind of definition of switch operation on the touchpad. It is envisioned that the user can select a template of switch operation, assign individual switches an operation of choice, or a combination of theses.

FIG. 2 shows the steering wheel 12 in greater detail. In the preferred embodiment, the touchpad input device 14 is positioned on one of the steering wheel spokes, thus placing it in convenient position for input character strokes drawn by the fingertip of the driver. The multifunction switches 20 are located on the opposite spoke. If desired, the touchpad and multifunction switches can be connected to the steering wheel using suitable detachable connectors to allow the position of the touchpad and multifunction switches to be reversed for the convenience of left handed persons. The touchpad may have embedded pushbutton switches or dedicated regions where key press selections can be made. Typically such regions would be arranged geometrically, such as in the four corners, along the sides, top and bottom and in the center. Accordingly, the touchpad input device 14 can have switch equivalent positions on the touchpad that can be operated to accomplish the switching functions of switches 20. It is envisioned that the touchpad can be used to draw characters when a character is expected, and used to actuate switch functions when a character is not expected. Thus, dual modes of operation for the touchpad can be employed, with the user interface switching between the modes based on a position in a dialogue state machine.

The human machine interface concept can be deployed in both original equipment manufacture (OEM) and aftermarket configurations. In the OEM configuration it is frequently most suitable to include the electronic components in the head unit associated with the entertainment system. In an aftermarket configuration the electronic components may be implemented as a separate package that is powered by the vehicle electrical system and connected to the existing audio amplifier through a suitable audio connection or through a wireless radio (e.g., FM radio, Bluetooth) connection.

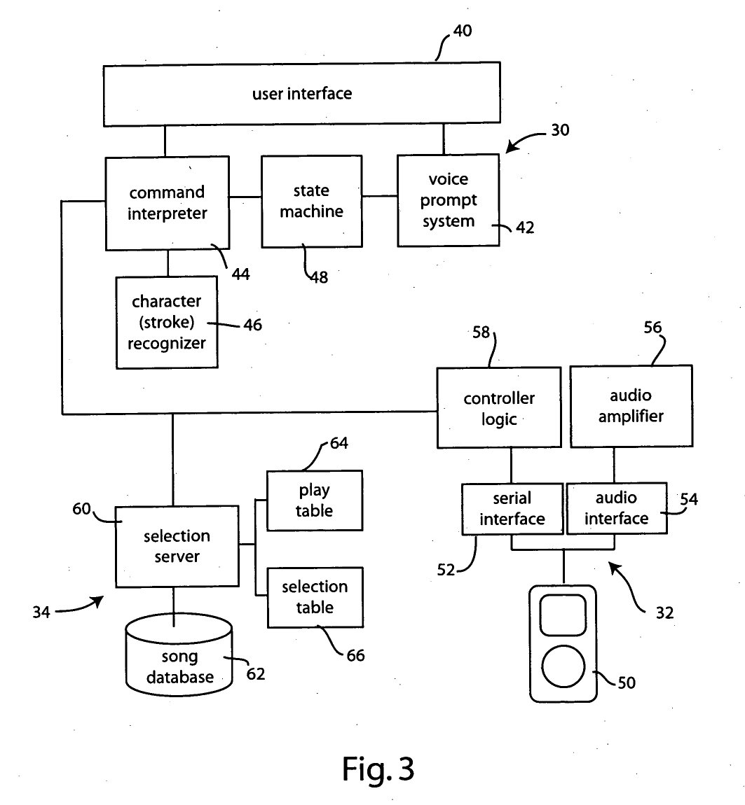

FIG. 3 depicts an exemplary embodiment that may be adapted for either OEM or aftermarket use. This implementation employs three basic subsections: the human machine interface subsection 30, the digital media player interface subsection 32, and a database subsection 34. The human machine interface subsection includes a user interface module 40 that supplies textual and visual information through the displays (e.g., heads-up display 16 and display panel 18 of FIG. 1). The human machine interface also includes a voice prompt system 42 that provides synthesized voice prompts or feedback to the user through the audio portion of the automotive entertainment system.

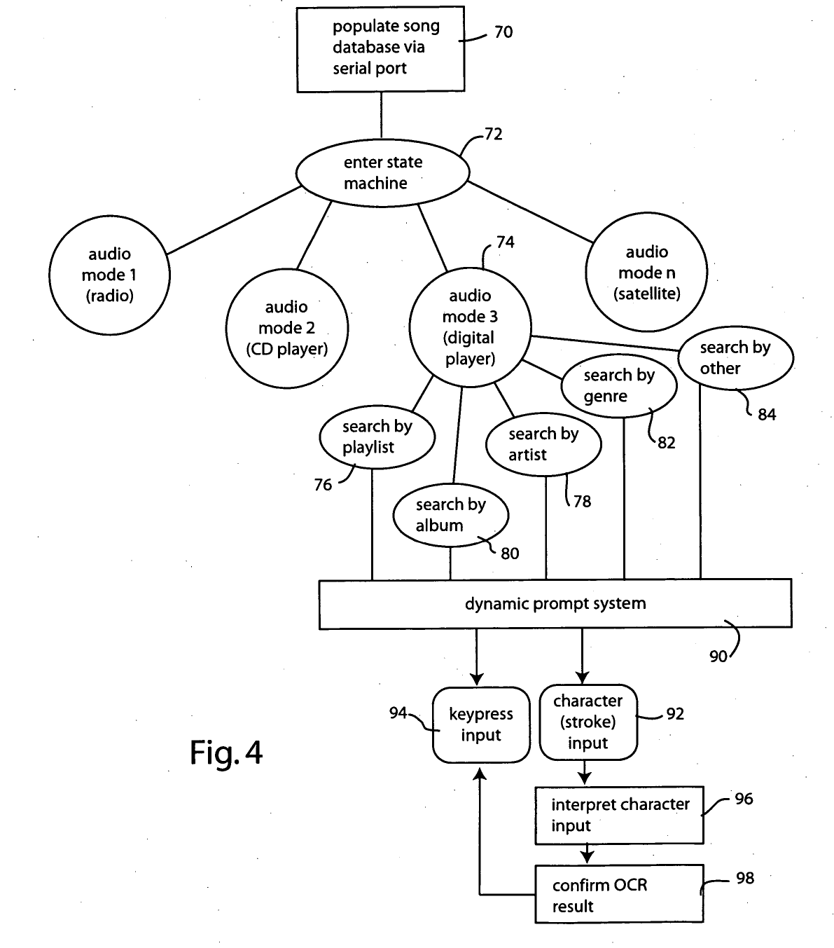

Coupled to the user interface module 40 is a command interpreter 44 that includes a character or stroke recognizer 46 that is used to decode the hand drawn user input from the touchpad input device 14. A state machine 48 (shown more fully in FIG. 4) maintains system knowledge of which mode of operation is currently invoked. The state machine works in conjunction with a dynamic prompt system that will be discussed more fully below. The state machine controls what menu displays are presented to the user and works in conjunction with the dynamic prompt system to control what prompts or messages will be sent via the voice prompt system 42.

The state machine can be reconfigurable. In particular, there can be different search logic implementations from which the user can select one to fit their needs. For example, when trying to control the audio program, some people need to access the control of the audio source (e.g., FM/AM/satellite/CD/ . . . ) most often, so these controls can be provided at a first layer of the state machine. On the other hand, some people need to access the equalizer most often, so these controls can be provided at the first layer.

The digital media player subsection 32 is shown making an interface connection with a portable media player 50, such as an iPod™. For iPod™ connectivity, the connection is made through the iPod™ dock connector. For this purpose, both a serial interface 52 and an audio interface 54 are provided. The iPod™ dock connector supplies both serial (USB) and audio signals through the dock connector port. The signals are appropriately communicated to the serial interface and audio interface respectively. The audio interface 54 couples the audio signals to the audio amplifier 56 of the automotive entertainment system. Serial interface 52 couples to a controller logic module 58 that responds to instructions received from the human machine interface subsection 30 and the database subsection 34 to provide control commands to the media player via the serial interface 52 and also to receive digital data from the media player through the serial interface 52.

The database subsection 34 includes a selection server 60 with an associated song database 62. The song database stores playlist information and other metadata reflecting the contents of the media player (e.g., iPod™ 50). The playlist data can include metadata for various types of media, including audio, video, information of recorded satellite programs, or other data. The selection server 60 responds to instructions from command interpreter 44 to initiate database lookup operations using a suitable structured query language (SQL). The selection server populates a play table 64 and a selection table 66 based on the results of queries made of the song database at 62. The selection table 66 is used to provide a list of items that the user can select from during the entertainment selection process. The play table 64 provides a list of media selections or songs to play. The selection table is used in conjunction with the state machine 48 to determine what visual display and/or voice prompts will be provided to the user at any given point during the system navigation. The play table provides instructions that are ultimately used to control which media content items (e.g., songs) are requested for playback by the media player (iPod).

When the media player is first plugged in to the digital media player subsection 32, an initializing routine executes to cause the song database 62 to be populated with data reflecting the contents of the media player. Specifically, the controller logic module 58 detects the presence of a connected media player. Then, the controller logic module can send a command to the media player that causes the media player to enter a particular mode of operation, such as an advanced mode. Next, the controller logic module can send a control command to the media player requesting a data dump of the player's playlist information, including artist, album, song, genre and other metadata used for content selection. If available, the data that is pumped can include the media player's internal content reference identifiers for accessing the content described by the metadata. The controller logic module 58 routes this information to the selection server 60, which loads it into the song database 62. It is envisioned that a plurality of different types of ports can be provided for connecting to a plurality of different types of media players, and that controller logic module 58 can distinguish which type of media player is connected and respond accordingly. It is also envisioned that certain types of connectors can be useful for connecting to more than one type of media player, and that controller logic module can alternatively or additionally be configured to distinguish which type of media player is connected via a particular port, and respond accordingly.

It should be readily understood that some media players can be capable of responding to search commands by searching using their own interface and providing filtered data. Accordingly, while it is presently preferred to initiate a data dump to obtain a mirror of the metadata on the portable media player, and to search using the constructed database, other embodiments are also possible. In particular, additional and alternative embodiments can include searching using the search interface of the portable media player by sending control commands to the player, receiving filtered data from the player, and ultimately receiving selected media content from the player for delivery to the user over a multimedia system of the vehicle.

FIG. 4 shows a software diagram useful in understanding the operation of the components illustrated in FIG. 3. The functionality initially used to populate the song database via the serial port is illustrated at 70. Once the database has been populated, there is ordinarily no need to re-execute this step unless the media player is disconnected and it or another player is subsequently connected. Thus, after the initializing step 70, the system enters operation within a state machine control loop illustrated at 72. As shown in FIG. 3, the state machine 48 is responsive to commands from the command interpreter 44. These commands cause the state machine to enter different modes of operation based on user selection. For illustration purposes, the following modes of operation have been depicted in FIG. 4: audio mode 1 (radio); audio mode 2 (CD player); audio mode 3 (digital player); and audio mode n (satellite). It will, of course, be understood that an automotive entertainment system may include other types of audio/video playback systems; thus the audio modes illustrated here are intended only as examples.

Each of the audio modes may have one or more available search selection modes. In FIG. 4, the search selection modes associated with the digital player (audio mode 3) have been illustrated. To simplify the figure, the search modes associated with the other audio modes have not been shown. For illustration purposes here, it will be assumed that the user selected the digital player (audio mode 3).

Having entered the audio mode 3 as at 74, the user is presented with a series of search mode choices. As illustrated, the user can select search by playlist 76, search by artist 78, search by album 80, and search by genre 82. To illustrate that other search modes are also possible, a search by other mode 84 has been illustrated here. Once the user selects a search mode, he or she is prompted to make further media selections. The dynamic prompt system 90 is invoked for this purpose. As will be more fully explained below, the dynamic prompt system has knowledge of the current state machine state as well as knowledge of information contained in the selection table 66 (FIG. 3). The dynamic prompt system makes intelligent prompting decisions based on the current search mode context and based on the nature of the selections contained within the selection table. If, for example, the user is searching by playlist, and there are only two playlists, then it is more natural to simply identify both to the user and allow the user to select one or the other by simple up-down key press input. On the other hand, if there are 50 playlists, up-down key press selection becomes tedious, and it is more natural to prompt the user to supply a character input (beginning letter of the desired playlist name) using the touchpad.

Accordingly, as illustrated, the dynamic prompt system includes a first mechanism for character (stroke) input 92 and a second mechanism for key press input 94. In a presently preferred embodiment the character or stroke input performs optical character recognition upon a bitmapped field spanning the surface area of the keypad. In an alternate embodiment the character or stroke input performs vector (stroke) recognition. In this latter recognition scheme both spatial and temporal information is captured and analyzed. Thus such system is able to discriminate, for example, between a clockwise circle and a counterclockwise circle, based on the spatial and temporal information input by the user's fingertip. Key press input may be entered either via the multifunction switches 20, or via embedded pushbutton switches or regions within the touchpad input device 14, according to system design.

As might be expected, in a moving vehicle it can sometimes be difficult to neatly supply input characters. To handle this, the recognition system is designed to work using probabilities, where the recognizer calculates a likelihood score for each letter of the alphabet, representing the degree of confidence (confidence level) that the character (stroke) recognizer assigns to each letter, based on the user's input. Where the confidence level of a single character input is high, the results of that single recognition may be sent directly to the selection server 60 (FIG. 3) to retrieve all matching selections from the database 62. However, if recognition scores are low, or if there is more than one high scoring candidate, then the system will supply a visual and/or verbal feedback to the user that identifies the top few choices and requests the user to pick one. Thus, when the character or stroke input mechanism 92 is used, the input character is interpreted at 96 and the results are optionally presented to the user to confirm at 98 and/or select the correct input from a list of the n-most probable interpretations.

It should be readily understood that vector (stroke) data can be used to train hidden markov models or other vector-based models for recognizing handwritten characters. In such cases, user-independent models can be initially provided and later adapted to the habits of a particular user. Alternatively or additionally, models can be trained for the user, and still adapted over time to the user's habits.

It is envisioned that models can be stored and trained for multiple drivers, and that the drivers' identities at time of use can be determined in a variety if ways. For example, some vehicles have different key fobs for different users, so that the driver can be identified based on detection of presence of a particular key fob in the vehicle. Also, some vehicles allow drivers to save and retrieve their settings for mirror positions, seat positions, radio station presets, and other driver preferences; thus the driver identity can be determined based on the currently employed settings. Further, the driver can be directly queried to provide their identity. Finally, the driver identity can be recognized automatically by driver biometrics, which can include driver handwriting, speech, weight in the driver's seat, or other measurable driver characteristics.

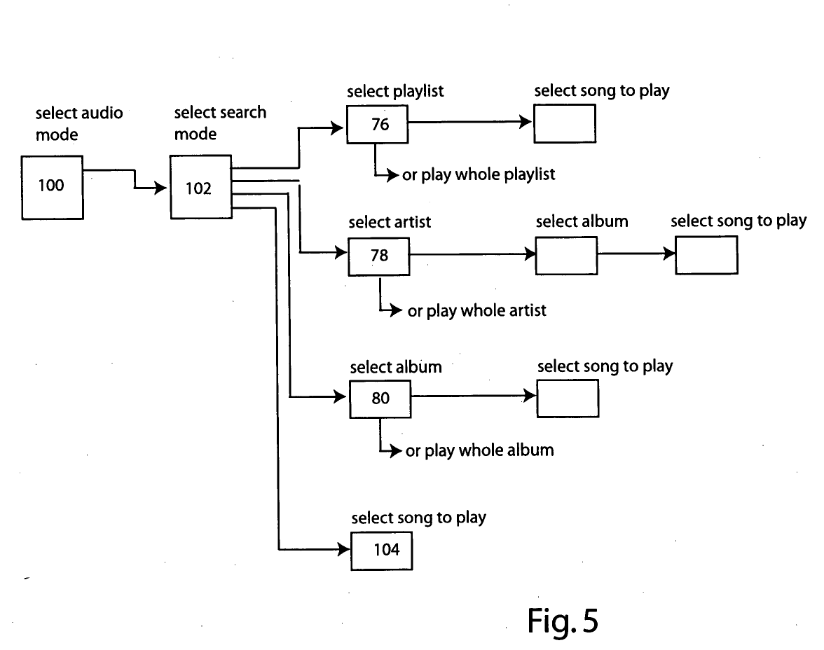

FIG. 5 shows the selection process associated with the state machine 48 in more detail. The illustrated selection tree maps onto a subset of the state machine states illustrated in FIG. 4 (specifically the search by playlist, search by artist, and search by album).

Beginning at 100, the user is prompted to select an audio mode, such as the audio mode 3 (digital player) selection illustrated at 74 in FIG. 4. State 100 represents the set of choices that are available when the system first enters the state machine at 72 in FIG. 4. Having made an audio mode selection, the user is next presented with a list of search mode selection choices at 102. The user may choose to search by playlist (as at 76), by artist (as at 78), by album (as at 80), and so forth. In the alternative, the user may simply elect to select a song to play without further filtering of the database contents. Thus the user is presented with the choice at 104 to simply select a song to play. Depending on the number of songs present, the user will be prompted to either use character input, key press input, or a combination of the two.

In many cases the media player will store too many songs to make a convenient selection at state 104. Thus a user will typically select a search mode, such as those illustrated at 76, 78, and 80, to narrow down or filter the number of choices before making the final selection. As illustrated, each of these search modes allows the user to select an individual song from the filtered list or to play the entire playlist, artist list, album list or the like, based on the user's previous selection.

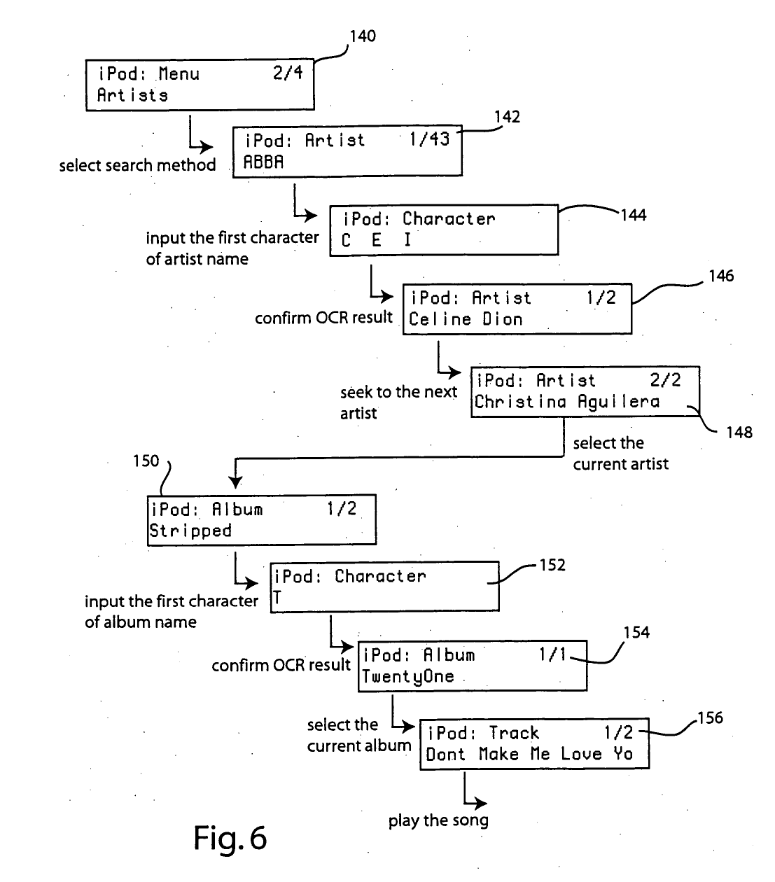

To more fully appreciate how the human machine interface might be used to make a song selection, refer now to FIG. 6. FIG. 6 specifically features a small alphanumeric display of the type that might be deployed on a vehicle dashboard in a vehicle that does not have a larger car navigation display screen. This limited display has been chosen for illustration of FIG. 6 to show how the human machine interface will greatly facilitate content selection even where resources are limited. Beginning at 140, the example will assume that the user has selected the search by artist mode. This might be done, for example, by pressing a suitable button on the multifunction keypad when the word “Artists” is shown in the display, as illustrated at 140.

Having selected search by artist mode, the display next presents, at 142, the name of the first artist in the list. In this case the artist identified as Abba. If the first listed artist is, in fact, the one the user is interested in, then a simple key press can select it. In this instance, however, the user wishes a different artist and thus enters a character by drawing it on the touchpad. As illustrated at 144, the optical character recognition system is not able to interpret the user's input with high probability and thus it presents the three most probable inputs, listed in order of descending recognition score.

In this case, the user had entered the letter ‘C’ and thus the user uses the multifunction keypad to select the letter ‘C’ from the list. This brings up the next display shown at 146. In this example, the first artist beginning with the letter ‘C’ happens to be Celine Dion. In this example, however, there are only two artists whose names begin with the letter ‘C’. The user is interested in the second choice and thus uses the touchpad to select the next artist as illustrated at 148.

Having now selected the artist, the user may either play all albums by that artist or may navigate further to select a particular album. In this example the user wishes to select a specific album. It happens that the first album by the listed artist is entitled “Stripped.” Thus, the display illustrates that selection at 150. In this case the user wants to select the album entitled “Twenty-One,” so she enters the letter ‘T’ on the touchpad and is asked to confirm that recognition. Having confirmed the recognition, the album “Twenty-One” is displayed at 154. Because this is the album the user is interested in listening to, she next views the first song on that album as illustrated at 156. Electing to hear that song she selects the play the song choice using the keypad. Although it is possible to navigate to the desired song selection using the visual display, as illustrated in FIG. 6, the dynamic prompt system also can utilize the voice prompt system 42 (FIG. 3) to provide dynamic voice feedback to the user. Table I below illustrates possible text that might be synthesized and played over the voice prompt system corresponding to each of the numbered display screens of FIG. 6. In Table I, the designation, Dynamic, is inserted where the actual voice prompt will be generated dynamically, using the services of the dynamic prompt generator 90.

TABLE I

| Display Screen | |
|---|---|
| Number | Associated Voice Feedback |
| 140 | “Your audio is in iPod ™ mode. Please select a search |
| | method from playlist, artist, album or press the left and right |
| | switch on the touchpad to line up or line down. Press the |
| | center switch of the touchpad to make a selection.” |
| 142 | “You selected search by artist. There are 50 artists. |
| | (Dynamic) You can write the first character of the artist name |
| | on the touchpad for a quick search. Or you can press the left |
| | and right switch on the touchpad to line up and line down.” |
| 144 | “Did you write ‘C’? or ‘E’? or ‘I’? (Dynamic) Press the left or right |
| | switch on the touchpad to highlight the correct character and press |
| | the center switch to confirm. If none of the characters is correct, |
| | press the top switch and try again.” |
| 146 | “In the ‘C’ section, there are two artists, Celine Dion and Christina |
| | Aguilera. (Dynamic). Press the left or right switch on the touchpad to line |
| | up or line down and then press the center switch to confirm.” |
| 148 | |
| 150 | “You have selected Christina Aguilera. There are two albums |
| | for Christina Aguilera. (Dynamic) Press the left or right |
| | switch on the touchpad to line up or line down and then press |
| | the center switch to confirm. Or write the first character of the album name |
| | on the touchpad for a quick search.” |
| 152 | “Did you write ‘T’? (Dynamic) If it is, press the center switch |
| | to confirm. If not, press the top switch and write again.” |
| 154 | “In the ‘T’ section, there is one album, Twenty-One. |
| | (Dynamic) If you wish to see the tracks in this album, press |
| | the center switch. If you wish to play all the tracks in this |
| | album, press the bottom switch. You can always press the |
| | top switch to go back.” |
| 156 | “Now playing album Twenty-One. (Dynamic) Press the left or |
| | right switch to seek backward and forward and then press the |
| | center switch to play. Press the bottom switch to stop or |
| | resume. You can always press the top switch to go back.” |

In alternative or additional embodiments, the dynamic response system can adapt to the user's preferences by employing heuristics and/or by allowing the user to specify certain preferences. For example, it is possible to observe and record the user's decisions regarding whether to select from the list or narrow the list in various cases. Therefore, it can be determined whether the user consistently chooses to further narrow the list whenever the number of selections exceeds a given number. Accordingly, a threshold can be determined and employed for deciding whether to automatically prompt the user to select from the list versus automatically prompting the user to narrow the list. As a result, a dialogue step can be eliminated in some cases, and the process therefore streamlined for a particular user. Again, in the case of multiple users, these can be distinguished and the appropriate user preferences employed.

It should also be readily understood that the aforementioned human machine interface can be employed to provide users access to media content that is stored in memory of the vehicle, such as a hard disk of a satellite radio, or other memory. Accordingly, users can be permitted to access media content of different system drives using the human machine interface, with a media player temporarily connected to the vehicle being but one type of drive of the system. Moreover, the system can be used to allow users to browse content available for streaming over a communications channel. As a result, a consistent user experience can be developed and enjoyed with respect to various types of media content available via the system in various ways.

What is claimed is:

1. A human machine interface device for automotive entertainment systems, the device comprising:
one or more user interface input components receiving user drawn characters and selection inputs from a user;
one or more user interface output components communicating prompts to the user; and
a browsing module connected to said user interface input components and said user interface output components, wherein said browsing module is adapted to filter media content based on the user drawn characters, deliver media content to the user based on the selection inputs, and prompt the user to provide user drawn characters and user selections in order to filter the media content and select the media content for delivery.

2. The system of claim 1, wherein said user interface input components include a collection of multifunction switches and a touchpad input device mounted on a steering wheel, wherein the switches and touchpad are used to receive human input commands for controlling audio-video equipment and selecting particular entertainment content.

3. The system of claim 2, wherein functions of the touchpad can be defined by the user in accordance with user preference.

4. The system of claim 1, wherein said user interface output components include a display device providing visual feedback.

5. The system of claim 4, wherein the display includes a heads-up display and a dashboard-mounted display panel, wherein the heads-up display projects a visual display onto the vehicle windshield, and the display panel is at least one of a dedicated display for use with an automotive entertainment system, or is combined with other functions.

6. The system of claim 4, wherein the display includes at least one of a heads up display, a display panel in a vehicle dash, a display in a vehicle instrument cluster, or a display in a vehicle rear view mirror.

7. The system of claim 1, wherein said browsing module includes a data processor having a human machine interface subsection that includes a user interface module supplying textual and visual information through said user interface output components, and a voice prompt system that provides synthesized voice prompts or feedback to a user through an audio portion of an automotive entertainment system.

8. The system of claim 1, further comprising a command interpreter including a character or stroke recognizer that is used to decode hand drawn user input from a touchpad input device of said user interface input components.

9. The system of claim 8, wherein said character or stroke recognizer automatically adapts to different writing styles.

10. The system of claim 1, further comprising a state machine maintaining system knowledge of which mode of operation is currently invoked, wherein said state machine controls what menu displays are presented to the user, and works in conjunction with the dynamic prompt system to control what prompts or messages are communicated to the user via a voice prompt system of said user interface output components.

11. The system of claim 10, wherein said state machine is reconfigurable by user selection of a search logic implementation.

12. The system of claim 1, wherein said browsing module includes a digital media player subsection that is operable to make an interface connection with a portable media player, and that has a controller logic module that responds to instructions to provide control commands to the media player and also to receive digital data from the media player.

13. The system of claim 12, wherein said browsing module is adapted to form a database by downloading metadata from the media player, and search contents of the media player by searching the database.

14. The system of claim 12, wherein said browsing module is adapted to search contents of the media player by using a search interface of the media player to directly search within a database on the media player.

15. The system of claim 1, wherein said browsing module is adapted to connect to a media player via wired and wireless two-way communication, to send control messages to the media player, and to receive multimedia information from the media player for delivery to the user via a vehicle multimedia system.

16. The system of claim 1, wherein said browsing module includes a database subsection having a selection server with an associated song database that stores playlist information and other metadata reflecting contents of a media player, and the selection server responds to instructions from a command interpreter to initiate database lookup operations using a suitable structured query language.

17. The system of claim 16, wherein the selection server populates a play table and a selection table based on results of queries made of the song database, the selection table being used to provide a list of items that the user can select from during an entertainment selection process, and the play table providing a list of media selections or songs to play.

18. The system of claim 17, wherein the selection table is used in conjunction with a state machine to determine at least one of what visual display or voice prompts will be provided to the user at any given point during system navigation, and the play table provides instructions that are ultimately used to control which media content items are requested for playback by the media player.

19. The system of claim 1, wherein when a media player is first plugged in to said browsing module, an initializing routine executes to cause a song database to be populated with data reflecting contents of the media player.

20. The system of claim 19, wherein a controller logic module of said browsing module detects the presence of the media player, sends a command to the media player requesting a data dump of the player's playlist information.

21. The system of claim 20, wherein the playlist information includes artist, album, song, genre and other metadata used for content selection.

22. The system of claim 1, wherein said browsing module presents the user with a series of search mode choices, and allows the user to select to at least one of search by playlist, search by artist, search by album, or search by genre.

23. The system of claim 1, wherein said browsing module is adapted to invoke a dynamic prompt system that makes intelligent prompting decisions based on a number of available selections.

24. The system of claim 23, wherein, depending on the number of available selections, the dynamic prompting system is adapted to prompt the user to either use character input, key press input, or a combination of the two.

25. The system of claim 1, wherein said browsing module performs optical character recognition upon a bitmapped field spanning a surface area of a touchpad of said user interface input components.

26. The system of claim 1, wherein said browsing module performs vector (stroke) recognition of an input character by capturing and analyzing both spatial and temporal information.

27. A human machine interface method for automotive entertainment systems, the method comprising:
receiving user drawn characters and selection inputs from a user;
filtering media content based on the user drawn characters;
delivering media content to the user based on the selection inputs; and
prompting the user to provide the user drawn characters and user selections in order to filter the media content and select the media content for delivery.

28. The method of claim 27, further comprising employing a collection of multifunction switches and a touchpad input device mounted on a steering wheel to receive human input commands for controlling audio-video equipment and selecting particular entertainment content.

29. The method of claim 27, further comprising employing a display device providing visual feedback, including a heads-up display and a dashboard-mounted display panel, wherein the heads-up display projects a visual display onto the vehicle windshield, and the display panel is at least one of a dedicated display for use with the automotive entertainment system, or is combined with other functions.

30. The method of claim 27, further comprising employing a data processor having a human machine interface subsection that includes a user interface module supplying textual and visual information, and a voice prompt system that provides synthesized voice prompts or feedback to a user through an audio portion of an automotive entertainment system.

31. The method of claim 27, further comprising employing a character or stroke recognizer to decode hand drawn user input from a touchpad input device.

32. The method of claim 27, further comprising maintaining system knowledge of which mode of operation is currently invoked, and employing the system knowledge to control what prompts or messages are communicated to the user.

33. The method of claim 27, further comprising:
making an interface connection with a portable media player; and
responding to instructions to provide control commands to the media player and to receive digital data from the media player.

34. The method of claim 27, further comprising:
storing playlist information and other metadata reflecting contents of a media player in a song database; and
responding to instructions to initiate database lookup operations in targeting the song database using a suitable structured query language.

35. The method of claim 34, further comprising:
populating a play table and a selection table based on results of queries made of the song database;
using the selection table to provide a list of items that the user can select from during an entertainment selection process; and
employing the play table to provide a list of media selections or songs to play.

36. The method of claim 35, further comprising:
employing the selection table in conjunction with a state machine to determine at least one of what visual display or voice prompts will be provided to the user at any given point during system navigation; and
employing the play table to provides instructions that are ultimately used to control which media content items are requested for playback by the media player.

37. The method of claim 27, further comprising:
detecting connection to a media player; and
executing an initializing routine to cause a song database to be populated with data reflecting contents of the media player.

38. The method of claim 37, further comprising sending a command to the media player requesting a data dump of the player's playlist information, including artist, album, song, genre and other metadata used for content selection.

39. The method of claim 27, further comprising:
presenting the user with a series of search mode choices; and
allowing the user to select to at least one of search by playlist, search by artist, search by album, or search by genre.

40. The method of claim 27, further comprising:
invoking a dynamic prompt system that makes intelligent prompting decisions based on a number of available selections.

41. The method of claim 40, further comprising prompting the user to either use character input, key press input, or a combination of the two based on the number of available selections.

42. The method of claim 27, further comprising performing optical character recognition upon a bitmapped field spanning a surface area of a touchpad.

43. The method of claim 27, further comprising performing vector (stroke) recognition of an input character by capturing and analyzing both spatial and temporal information.
